(19) United States
(12) Patent Application Publication
(10) Pub. No.: US 2008/0037815 A1
(43) Pub. Date: Feb. 14, 2008

(54) CONDENSER MICROPHONE

(75) Inventors: Motoaki ITO, Shizuoka-shi (JP); Yoshio Imahori, Shizuoka-shi (JP); Hiroshi Fujinami, Shizuoka-shi (JP); Kentaro Yonehara, Shizuoka-shi (JP)

Correspondence Address: SUGHRUE-265550, 2100 PENNSYLVANIA AVE. NW, WASHINGTON, DC, 20037-3213, US

(73) Assignee: STAR MICRONICS CO., LTD., Shizuoka-shi (JP)

(21) Appl. No.: 11/836,901

(22) Filed: Aug. 10, 2007

(30) Foreign Application Priority Data
Aug. 10, 2006 (JP) 2006-218626
Aug. 24, 2006 (JP) 2006-227611

(51) Int. Cl. H04R 19/04

(52) U.S. Cl. 381/355

(57) ABSTRACT

A condenser microphone includes: a condenser portion including a vibration film and a plate disposed opposed to each other; an impedance conversion unit that converts the variations of the electrostatic capacity of the condenser portion to electric impedances; and a box member that stores the condenser portion and the impedance conversion unit therein, and includes a heat insulating portion.

### CROSS REFERENCE TO RELATED APPLICATION

This application claims priority from a Japanese Patent Application No. 2006-218626 filed on Aug. 10, 2006, and a Japanese Patent Application No. 2006-227611 filed on Aug. 24, 2006, the entire subject matter of which is incorporated herein by reference.

### TECHNICAL FIELD

The present invention relates to a microphone box member for a condenser microphone used in equipment such as a cellular phone, a video camera and a personal computer, and a condenser microphone.

### BACKGROUND

As a microphone of this type, for example, there is known a microphone which is disclosed in the below-cited JP-A-2004-222091. This is a condenser microphone of an electret type is structured such that a circuit board with electric parts mounted thereon, a back electrode substrate including a back electrode, an electret layer and a spacer unified together on an insulation substrate, and a vibration film unit including a vibration film stretched on a support frame are piled up and stored in a shield case made of metal.

Also, there is proposed another condenser microphone which is disclosed, for example, in the JP-A-2002-345092. This conventional condenser microphone is structured such that a circuit board with electric parts mounted thereon, a lower spacer, aback plate including aback electrode, an upper spacer, and a vibration film support frame with a vibration film stretched on the lower surface thereof are piled up sequentially in this order from the bottom and fixed together. In this type of condenser microphone including the condenser microphone disclosed in the JP-A-2004-222091, after the respective composing parts thereof are piled up and assembled together, the assembly is passed and heated through a reflow furnace, and, due to the heat thereof, the condenser microphone is reflow soldered onto a substrate which is to be mounted onto equipment.

### SUMMARY

Generally, an operation to mount a condenser microphone onto a circuit board provided on, for example, a cellular phone is carried out using reflow soldering. In the reflow soldering, the microphone is exposed to a high temperature such as a temperature of 260° C. In the condenser microphone disclosed in the JP-A-2004-222091, since the shield case is made of metal, the shield case is easily heated, the heat of the shield case is easily transmitted through the support frame to the vibration film, and the heat is also easily transmitted through the circuit board and insulating substrate to the back electrode and spacers. As a result of this, the temperature of the electret layer rises to thereby cause charge dissipation, or a clearance between the vibration film and back electrode substrate is caused to vary from a set value due to a difference between the coefficients of thermal expansion of the back electrode and spacers. This raises a problem that the characteristics of the microphone such as its sensitivity and S/N ratio can be worsened.

Further, since, as described above, the condenser microphone is heated in the reflow soldering, conventionally, in the condenser microphones having the conventional structure including the condenser microphone disclosed in the JP-A-2004-222091, in order to reduce the thermal damage of parts provided in the interior of the condenser microphone in the reflow soldering, there are taken countermeasures such as selection of materials which are high in heat resistance. However, there is employed no specific structure to restrict thermal conduction to the interior of the condenser microphone. Owing to this, conventionally, there is found a problem that heat in the reflow soldering is transmitted to the interior of the condenser microphone.

Aspects of the invention provide a condenser microphone which can prevent the worsening of the characteristics of the condenser microphone caused by heat applied thereto when the condenser microphone is reflow soldered to the substrate to be mounted on to the equipment.

Also, the present invention is made in order to solve the above-mentioned problems found in the conventional condenser microphone.

Thus, aspects of the invention provide a condenser microphone which can enhance the thermal insulating property of its box member and thus can reduce the ill thermal influences of the reflow soldering on composing parts provided in the box member.

According to a first aspect of the invention, there is provided a condenser microphone including: a condenser portion including a vibration film and a plate disposed opposed to each other; an impedance conversion unit that converts the variations of the electrostatic capacity of the condenser portion to electric impedances; and a box member that stores the condenser portion and the impedance conversion unit therein, and includes a heat insulating portion.

According to the first aspect, since the box member includes the heat insulating portion, the heat insulating property of the box member is enhanced and thus, in the reflow treatment, when the heat is applied thereto, the influences of the heat on the parts provided within the box member can be reduced.

According to a second aspect of the invention, in a condenser microphone according to the first aspect of the invention, wherein the box member is made of an insulating member; the box member includes: a base frame including a storage space formed to extend therethrough; and a substrate for closing the opening ends of the storage space; the box member stores an electro-acoustic conversion unit in the storage space; the substrate is formed in multiple layers including an insulating layer and a conductive layer in such a manner that the conductive layer is buried in the insulating layer; and the conductive layer is formed in a mesh-like shape to thereby form the heat insulating portion.

According to the second aspect, since the conductive layer is formed in a mesh-like shape and is buried in the insulating layer, the heat conductivity of the substrate is lowered. Owing to this, when mounting the condenser microphone by reflow soldering, heat applied to the box member is made difficult to enter the interior of the box member. This can prevent the occurrence of an obstacle such as charge dissipation in the electro-acoustic conversion unit that could be otherwise caused by heat transmitted to the interior of the box member.

According to a third aspect of the invention, the conductive layer is electrically connected to a through hole formed in the substrate.

According to the third aspect, since the conductive layer can be electrically connected to the ground through the through hole, electromagnetic shield by the conductive layer can be attained.

According to a fourth aspect of the invention, the substrate includes a first substrate having a circuit pattern for the impedance conversion unit for closing one opening end of the storage space and a second substrate having a sound hole for closing the other opening end of the storage space, and the conductive layer is provided on at least one of the first and second substrates.

According to a fifth aspect of the invention, the substrate includes a sound hole and the conductive layer is formed so as to cross the sound hole.

According to the fifth aspect, since the conductive layer is situated within the sound hole, not only dust or the like can be prevented from entering the interior of the box member through the sound hole but also heat is difficult to enter the interior of the box member.

According to a sixth aspect of the invention, a hole formed in the conductive layer is filled with resin which constitutes the insulating layer.

And, according to a seventh aspect of the invention, the hole of the conductive layer configures a space.

According to these aspects, it is possible to prevent charge dissipation in the electret layer due to high heat.

According to an eighth aspect of the invention, the box member includes a cavity which is formed in the wall of the box member. According to this aspect, since the cavity is formed in the wall of the box member, the heat insulating property of the box member is enhanced and thus, in the reflow treatment or the like, when heat is applied to the box member, the ill influences of the heat on parts provided within the box member can be reduced.

According to a ninth aspect of the invention, the box member includes: a mounting substrate with the impedance conversion unit mounted thereon; a frame member having a pair of openings, with the peripheral edge of one opening being integrally connected to the mounting substrate and surrounding the impedance conversion unit; and a top cover substrate integrally connected to the peripheral edge of the other opening of the frame member. Further, the cavity is formed in at least one of the mounting substrate, frame member and top cover substrate. According to this aspect, since the cavity is formed in at least one of the mounting substrate, frame member and top cover substrate, the heat insulating property of the box member is enhanced and thus the ill influences of the heat in the reflow treatment on parts provided within the box member can be reduced.

According to a tenth aspect of the invention, the box member includes: a mounting substrate with the impedance conversion unit mounted thereon; a frame member having a pair of openings, with the peripheral edge of one opening being integrally connected to the mounting substrate and surrounding the impedance conversion unit; and, a top cover substrate integrally connected to the peripheral edge of the other opening of the frame member. Also, the cavity includes a through hole formed in the frame member, and a pair of opening ends of this through hole is closed by the mounting substrate and the top cover substrate.

According to an eleventh aspect of the invention, the box member having a cavity functioning as the heat insulating portion is made of a substrate including two or more metal layers. According to the eleventh aspect, since the box member is made of a substrate having two or more metal layers, the strength of the box member can be enhanced.

According to a twelfth aspect of the invention, the cavity of the frame member is formed so as to have a honeycomb structure. According to this aspect, since the cavity is formed to have a honeycomb structure, the portion of the frame member where the cavity is formed can be enhanced in strength.

According to a thirteenth aspect of the invention, there is provided a condenser microphone, wherein a box member includes: a circuit board with a die mounted thereon, the die including a microphone vibration portion produced according to a semiconductor process technology; a frame member connected to the circuit board and surrounding the die; and, a top cover substrate integrally connected to the frame member. Specifically, the present condenser microphone is characterized in that the box member stores the microphone vibration portion therein and includes in the wall thereof a cavity functioning as a heat insulating portion. According to this aspect, since the box member includes the cavity, the heat insulating property of the box member is enhanced and thus, in the reflow treatment or the like, when heat is applied to the box member, the ill influences of the heat on parts provided within the box member can be reduced.

According to a fourteenth aspect of the invention, the cavity is filled with the air. According to this aspect, since the cavity is filled with the air, an air layer is formed in the box member. As a result of this, in the reflow treatment, the ill influences of the heat on parts provided within the box member can be reduced.

According to a fifteenth aspect of the invention, the cavity is evacuated. According to this aspect, since the cavity is evacuated, a vacuum layer is formed in the cavity of the box member. This can enhance the heat insulating property of the box member further than the structure in which the air layer is formed in the cavity. Therefore, the ill influences of the heat in the reflow treatment on parts provided within the box member can be reduced.

According to the invention, since the through hole (cavity) is evacuated, differently from a structure in which the air exists in the cavity, there is eliminated the possibility that gas existing within the through hole can be thermally expanded due to the heat applied in the reflow treatment, which in turn eliminates a fear that the frame member and mounting substrate can be separated from each other as well as the frame member and top cover substrate can be separated from each other. Also, owing to the vacuum state of the through hole, an attracting force can be applied the mounting substrate and top cover substrate respectively connected to the frame member according to a pressure difference between the vacuum and the atmospheric pressure, whereby, after assembled, the separation of the mounting substrate and top cover substrate can be prevented.

According to the invention, it is possible to provide an excellent effect that the worsening of the microphone characteristics caused by heat applied in the reflow soldering when mounting the condenser microphone can be prevented.

Also, as described above, according to the invention, since a cavity is formed in the box member, the thermal insulation property of the box member is enhanced and thus, when heat is applied to the box member in the reflow soldering or the like, the influence of the heat on the composing parts provided in the box member can be reduced.

### BRIEF DESCRIPTION OF THE DRAWINGS

In the accompanying drawings:

FIG. 1 is a longitudinal section view of a condenser microphone according to a first embodiment of the invention;

FIG. 2 is an exploded perspective view of the above condenser microphone;

FIG. 3 is a transverse section view of a conductive layer provided on a top substrate used in the above condenser microphone;

FIG. 4 is a transverse section view of a conductive layer provided on a top substrate used in a second embodiment of the invention;

FIG. 5 is a longitudinal section view of a condenser microphone;

FIG. 6 is a longitudinal section view of a condenser microphone according to a third embodiment of the invention;

FIG. 7 is an exploded perspective view of the condenser microphone shown in FIG. 6;

FIG. 8 is a perspective view of parts used to manufacture a condenser microphone;

FIG. 9 is a section view of a condenser microphone according to a fourth embodiment of the invention.

### DETAILED DESCRIPTION

### First Embodiment

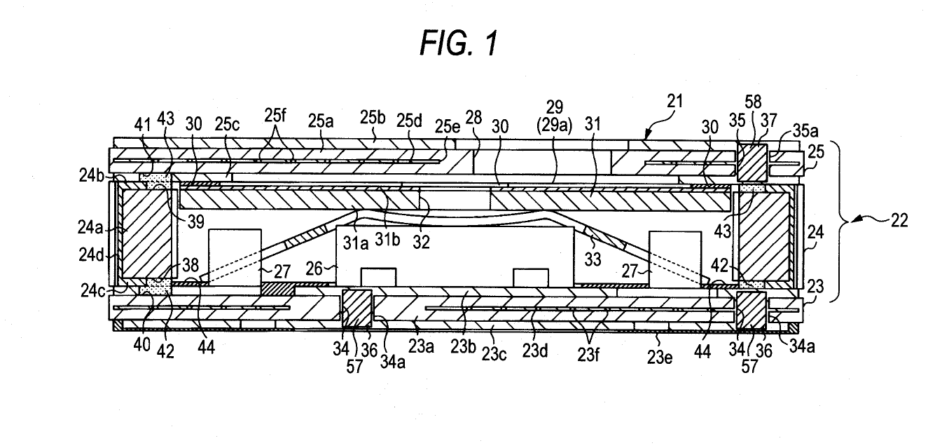

Next, description will be given below of a first embodiment in which the invention is embodied in a condenser microphone of an electret type, with reference to FIGS. 1 to 3.

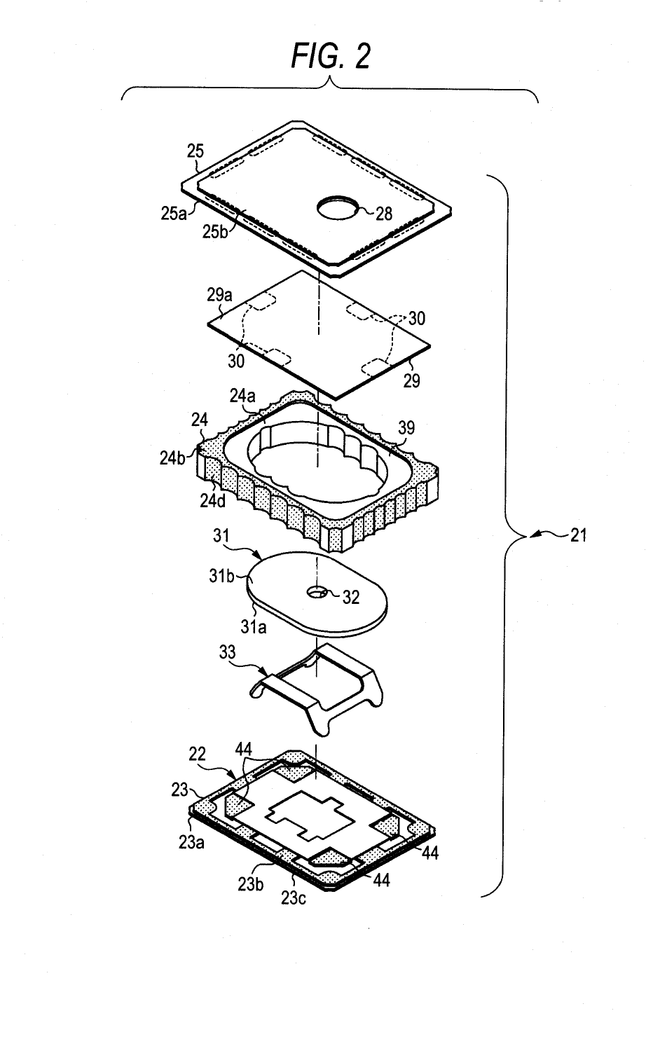

As shown in FIGS. 1 and 2, in a condenser microphone 21 according to the present embodiment, a box member 22 includes a flat-plate-shaped circuit board 23, a box member base frame 24 having a storage space penetrating therethrough and formed in a square-shaped frame as a whole, and a flat-plate-shaped top substrate 25, while these composing parts are sequentially piled up in this order from the bottom and are fixed together with adhesive. The circuit board 23, box member base frame 24 and top substrate 25 are respectively made of an electric insulator such as epoxy resin, liquid crystal polymer and ceramics.

On the upper and lower surfaces of a board main body 23a of the circuit board 23 which closes one side of the storage space of the box member base frame 24, there are printed conduction patterns 23b and 23c made of copper, respectively. At the desired positions of the upper and lower surfaces of the circuit board 23, there are printed insulation films 23e. And, on the circuit board 23, there are mounted electric parts such as a field effect transistor 26 and a capacitance 27 which constitute an impedance conversion unit provided within the box member 22; and, these electric parts are disposed in the storage space of the box member base frame 24. On the upper, lower and outer surfaces of the frame main body 24a of the box member base frame 24, there are printed conductive patterns 24b, 24c and 24d which are made of copper and are formed continuous with each other. On the upper and lower surfaces of the substrate main body 25a of the top substrate 25 which closes the other side of the storage space of the box member base frame 24, there are printed conductive patterns 25b and 25c which are made of copper, respectively. In the top substrate 25, there is formed a sound hole 28 which is used to take in sound from outside.

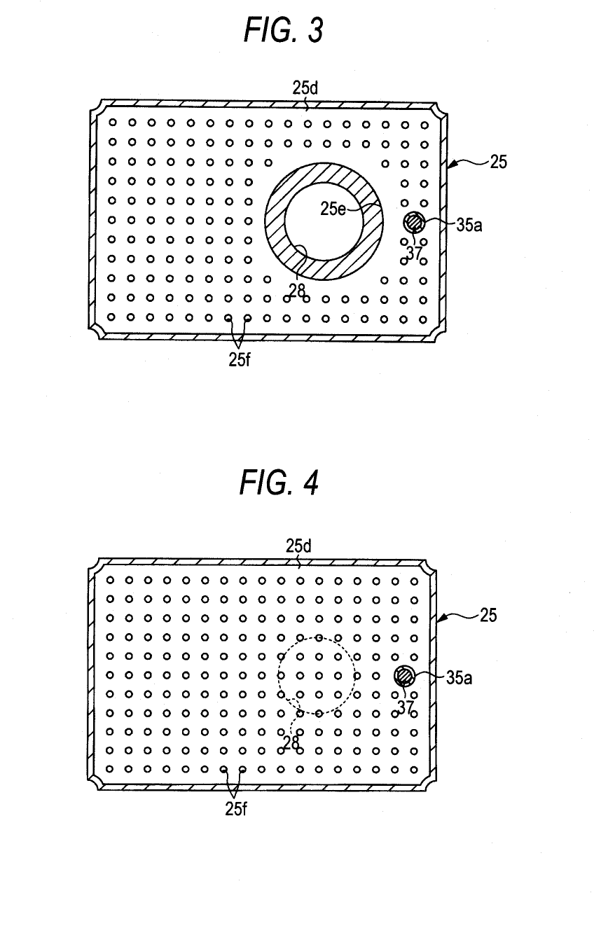

Further, in the respective interior portions of the circuit board 23 and top substrate 25, there are buried conductive layers 23d and 25d which are made of copper and function as heat insulating portions, respectively. As shown in FIGS. 1 and 3, the conductive layer 25d of the top substrate 25 has a hole 25e which corresponds to the sound hole 28. These conductive layers 23d and 25d are respectively formed in mesh-like shapes which respectively have a large number of minute penetration holes 23f and 25f. The penetration holes 23f and 25f are formed, for example, by laser beam machining or by etching. In the penetration holes 23f and 25f, there is filled electrically insulating resin of which the board main body 23a and substrate main body 25a are made. By the way, the conductive layers 23d and 25d may also be made by forming fine copper wires in net-like shapes.

As shown in FIGS. 1 and 2, within the box member base frame 24, to the lower surface of the ring-shaped conductive pattern 25c of the top substrate 25, there is glued a vibration film 29 in a stretched manner. The vibration film 29 is made of a synthetic resin thin film sheet material, specifically, PPS (Polyphenylene Sulfide). On the upper surface of the vibration film 29, there is formed a conductive layer 29a by gold deposition. At four positions of the vibration film 29 on the lower surface peripheral side thereof, there are glued and fixed four spacers 30 which are respectively made of the same system material (including the same material) as the vibration film 29, namely, synthetic resin such as PPS and are respectively composed of four small piece members. Within the box member base frame 24, a back plate 31 is disposed so as to be opposed to the lower surface of the vibration film 29 interposing the spacers 30. This back plate 31 is structured in such a manner that a film 31b made of PTFE (Polyterafluoroethylene) or the like is glued to the upper surface of a substrate 31a made of a stainless steel plate. On the film 31b, there has been enforced a poling treatment using corona discharge or the like and, owing to this poling treatment, the film 31b forms an electret layer. And, the back plate 31 forms a back pole and, therefore, the condenser microphone according to the present embodiment is of a back electret type. Further, in the central portion of the back plate 31, there is opened up a penetration hole 32 which is used to allow the movement of the air caused by the vibration of the vibration film 29. In the present embodiment, the impedance conversion unit, vibration film 29, back plate 31 and the like cooperate together in constituting an electro-acoustic conversion unit.

As shown in FIGS. 1 and 2, within the box member base frame 24, between the back plate 31 and circuit board 23, there is interposed a hold member 33 made of a plate spring member in a compressed manner and, owing to the elastic force of the hold member 33, the back plate 31 is pressed in a direction where the back plate 31 is contacted with the lower surfaces of the spacers 30 from the opposite side of the vibration film 29. This makes it possible to keep a clearance equivalent to the thickness of the spacers 30 between the vibration film 29 and back plate 31, whereby, between them, there is formed a condenser portion which can secure a given capacity. The hold member 33 can be formed by enforcing gold plating on both of the front and back surfaces of a stainless steel plate and, the back plate 31 is electrically connected through the hold member 33 to the terminals 44 of an impedance conversion circuit provided on the circuit board 23.

As shown in FIG. 1, in the circuit board 23 and top substrate 25, there are formed two or more through holes 34 and 35, respectively; and, on the respective inner peripheral surfaces of these through holes 34 and 35, there are provided conductive patterns 34a and 35a which are respectively connected continuously with their associated conductive patterns 23b, 23c and 25b, 25c. Also, into the through holes 34 and 35, there are filled conductive members 36 and 37 respectively. These conductive members 36, 37 and the conductive patters 34a, 35a cooperate together in constituting conductive portions 57 and 58. And, there is formed a conductive path which extends from the conductive portion 58 including the conductive patterns 25b, 25c and through holes 35 provided on the top substrate 25 through the conductive patterns 24b˜24d provided on the box member base frame 24 to the conductive patterns 23b and 23c provided on the circuit board 23, and further extends through the conductive portion 57 including the through holes 34 to a ground terminal (not shown).

As shown in FIGS. 1 and 2, in the inner peripheral edges of the lower and upper surfaces of the box member base frame 24, there are formed the exposure portions 38 and 39 of the frame main body 24a in which the conductive patterns 24c and 24b are not present, in such a manner that the exposure portions 38 and 39 are respectively formed in a ring shape as a whole. In the upper surface of the circuit board 23, there is formed more than one exposure portion 40 of the board main body 23a of the circuit board 23 in which the conductive pattern 23b is not present in such a manner that they are arranged along the ring-shaped area of the upper surface of the circuit board 23. In the lower surface of the top substrate 25, there is formed more than one exposure portion 41 of the substrate main body 25a in which the conductive pattern 25c is not present in such a manner that they are arranged along the ring-shaped area of the lower surface of the top substrate 25. Between the exposure portions 40 of the circuit board 23 and the exposure portion 38 of the box member base frame 24, and, between the exposure portions 41 of the top substrate 25 and the exposure portion 39 of the box member base frame 24, there are interposed adhesive members 42 and 43, respectively; and, these adhesive members 42 and 43 adhesively connect and fix the box member base frame 24 to the circuit board 23 and top substrate 25. In the other portions than the exposure portions 41 and 39, the conductive pattern 23b on the upper surface of the circuit board 23 and the conductive pattern 25c on the lower surface of the top substrate 25 are directly connected to the conductive pattern 24c on the lower surface of the box member base frame 24 and the conductive pattern 24b on the upper surface of the box member base frame 24, respectively, whereby the top substrate 25 is electrically connected to the box member base frame 24 and the box member base frame 24 is electrically connected to the circuit board 23.

In the above-structured condenser microphone 21 according to the present embodiment, when sound waves from a sound source arrive through the sound hole 28 of the top substrate 25 at the vibration film 29, the vibration film 29 is vibrated according to the frequencies, amplitudes and waveforms of the sound waves. And, with the vibration of the vibration film 29, a clearance between the vibration film 29 and back plate 31 is varied from its set value to thereby vary the impedance of the condenser. The variations of the impedance are converted by an impedance conversion circuit into a voltage signal, and the voltage signal is then output.

Now, when mounting the thus structured condenser microphone 21 onto, for example, the circuit board of a cellular phone by reflow soldering, high heat is going to invade the box member 22 through the circuit board 23 and top substrate 25. At the then time, the mesh-shaped conductive layers 23d and 25d, which are buried in the circuit board 23 and top substrate 25, prevent the heat transmitted to the circuit board 23 and top substrate 25 from being transmitted from the circuit board 23 and top substrate 25 to the interior of the box member base frame 24. The reason for this is that the conductive layers 23d and 25d having a large number of penetration holes 23f and 25f are respectively formed in a mesh-like shape and the insulating resin of the board main body 23a and substrate main body 25a is filled in the penetration holes 23f and 25f, whereby the conductive layers 23d and 25d are poor in heat conductivity when compared with the conductive layers not having the penetration holes 23f and 25f.

Thus, the film 31b of the back plate 31 is prevented from rising in temperature, which can prevent the electret layer against charge dissipation. Also, the spacer 30 and back plate 31 are prevented from rising in temperature, which can prevent the spacer 30 and back plate 31 against deformation which is caused by a difference between the thermal expansion ratios thereof. This can prevent the disordered stretch tension of the vibration film 29 and the disordered clearance between the vibration film 29 and back plate 31 which are respectively caused by the deformation of the spacer 30 and back plate 31. Therefore, there can be prevented the deteriorated characteristics of the condenser microphone such as the sensitivity and S/N ratio thereof which are caused by the charge dissipation of the electret layer, variations in the stretch tension of the vibration film 29, the disordered clearance and the like.

In the above-structured condenser microphone 21 according to the present embodiment, there can be provided the following effects.

(1) The mesh-shaped conductive layers 23d and 25d are buried in the circuit board 23 and top substrate 25, and electric insulation resin is filled into the penetration holes 23f and 25f thereof. Therefore, the thermal conductivities of the conductive layers 23d and 25d are lower than those of the conductive layers that are not formed in a mesh-like shape. This makes it difficult for the high heat applied to the box member 22 in the reflow soldering to enter the interior of the box member 22. Thus, it is possible to prevent the worsened characteristics of the condenser microphone such as the sensitivity and S/N ratio thereof that are caused by the heat applied to the film 31b, spacer 30, back plate 31 and the like.

(2) The conductive layers 23d and 25d of the circuit board 23 and top substrate 25 are electrically connected through the through holes 34 and 35 to the conductive patterns 23b, 23c, 25b, 25c of the circuit board 23 and top substrate 25. Therefore, not only by the respective conductive patterns 23b, 23c, 25b and 25c, but also by the respective conductive layers 23d and 25d, the condenser portion and impedance conversion circuit provided within the box member 22 can be shielded in an electromagnetic manner.

### Second Embodiment

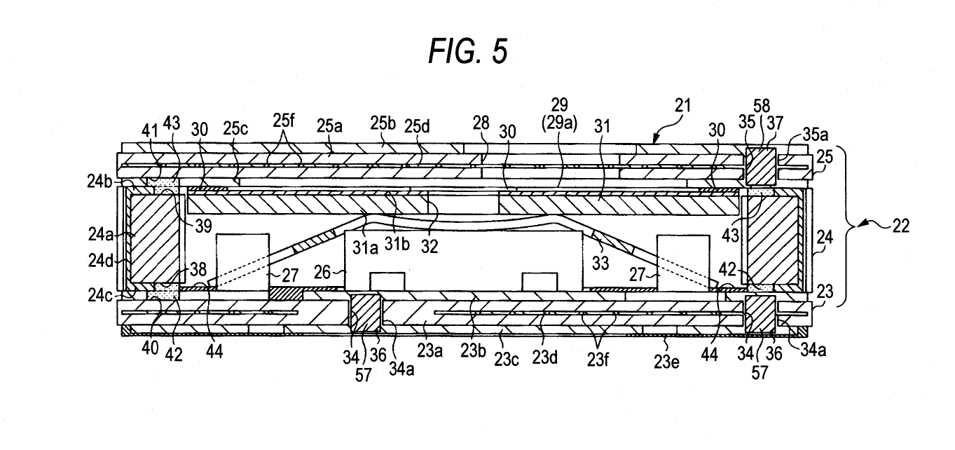

Next, description will be given below of a second embodiment in which the invention is embodied in a condenser microphone of an electret type, with reference to FIGS. 4 and 5. By the way, the present embodiment is different from the first embodiment only in that, in the condenser microphone 21 according to the first embodiment, the mode of the conductive layer 25d of the top substrate 25 is changed.

As shown in FIGS. 4 and 5, the conductive layer 25d according to the present embodiment does not include the hole 25e corresponding to the sound hole 28 but is formed to cross the sound hole 28. Therefore, the conductive layer 25d is exposed to the outside in the portion of the sound hole 28.

The thus structured condenser microphone 21 according to the present embodiment operates similarly to the condenser microphone 21 according to the first embodiment.

Especially, the present embodiment can provide the following effects in addition to the effects (1) and (2) that have been found in the first embodiment.

(3) Since the conductive layer 25d is situated within the sound hole 28, dust or the like can be prevented from entering the vibration film 29 through the sound hole 28, which can prevent the operation state of the vibration film 29 from being disturbed by the dust. By the way, sounds from the outside arrive at the vibration film 29 through the penetration holes 25f formed in the sound hole 28.

(4) Since the conductive layer 25d is formed in the portion of the sound hole 28 as well, not only the electromagnetic shielding property of the condenser microphone can be enhanced but also heat can be prevented from entering the interior of the box member 22 from the sound hole 28.

And, the present embodiment can also be changed and embodied in the following manner.

The board main body 23a and substrate main body 25a of the circuit board 23 and top substrate 25 are respectively formed in a multiple layer structure by piling up two or more insulation layers and the conductive layers 23d, 25d, no resin is filled into the penetration holes 23f and 25f of the conductive layers 23d and 25d but the penetration holes 23f and 25f are made hollow. Employment of this structure can prevent the heat transmission further.

Only one of the conductive layers 23d and 25d of the circuit board 23 and top substrate 25 is formed in a mesh-like shape.

While employing a structure in which the conductive layers 23d and 25d of the circuit board 23 and top substrate 25 are provided in two or more layers, the present invention is embodied.

The invention is embodied in a box member of a condenser microphone of a foil electret type in which, instead of providing an electret layer in the back plate 31, the vibration film 29 is formed of an electret layer.

The invention is embodied in a box member of a condenser microphone of a front electret type in which, instead of providing the back plate 31 including an electret layer, an electret layer is formed on the lower surface of the top substrate 25.

The invention is embodied in a box member of a condenser microphone of an MEMS (Micro Electro Mechanical System) type in which a condenser portion is including a vibration plate and fixed plate opposed to the vibration plate is formed on a silicone substrate according to a semiconductor process technology.

The invention is embodied in a box member of a condenser microphone of a change pump type in which no electret layer is included but a voltage is applied between the back plate 31 and vibration film 29 by an external charge pump circuit.

The invention is embodied in a box member of a condenser microphone in which a condenser portion is provided in a box member formed by injection molding, for example, synthetic resin.

The invention is embodied in the box members of microphones of various types such as a crystal type, a piezoelectric type, a magnetic type and a carbon type.

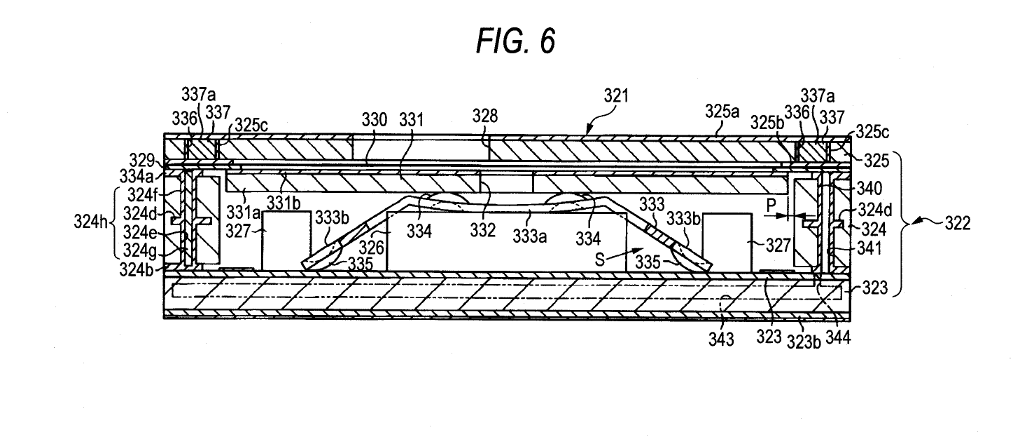

Next, description will be given below of a third embodiment with reference to FIGS. 6˜8.

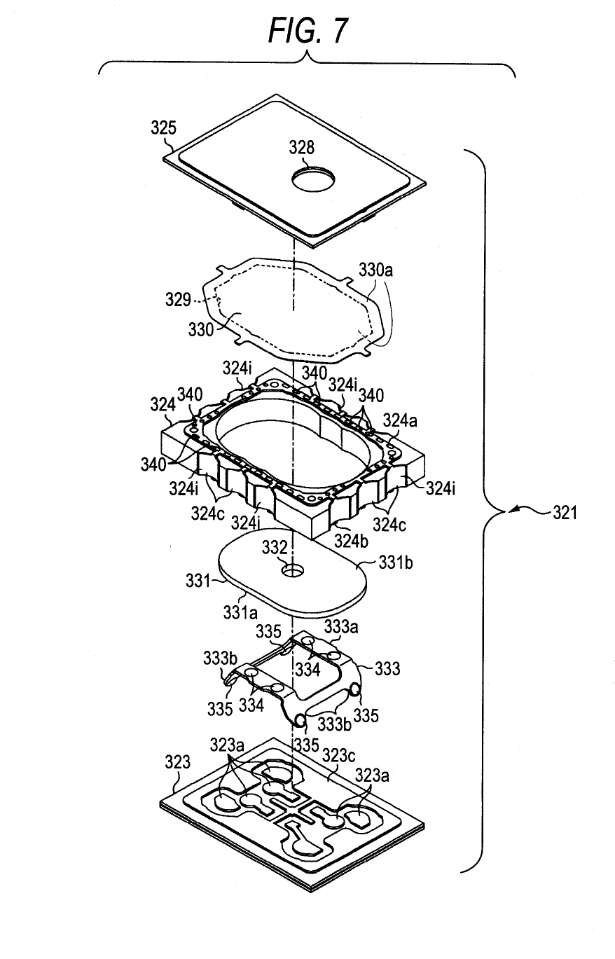

As shown in FIGS. 6 and 7, the box member 322 of a condenser microphone 321 according to the present embodiment is structured such that a flat-plate-shaped circuit board 323 functioning as amounting substrate, a square-frame-shaped box member base frame 324 functioning as a frame member and a flat-plate-shaped top substrate 325 functioning as a top cover are piled up and are fixed together into a unified body with adhesive. The circuit board 323, box member base frame 324 and top substrate 325 are respectively structured by an electric insulation member made of resin such as epoxy resin. In the present embodiment, the insulation member is made of glass cloth base epoxy resin; however, the material of the insulation member is not limited to the epoxy resin. On the upper surface of the circuit board 323, there are formed conductive patterns 323a and 323c which are respectively made of copper foil. The conductive pattern 323c is a conductive pattern for grounding and is provided in a frame shape so that it can face the frame shape of the box member 322. The conductive pattern 323a is a conductive pattern for connection of composing parts and can be used to input power and take out a value signal.

Also, on the lower surface of the circuit board 323, there is formed more than one conductive pattern 323b (in FIG. 6, only one conductive pattern 323b is shown) made of copper foil.

And, in the circuit board 323, there is formed more than one through hole (not shown) and, in these through holes, there are formed conductive patterns respectively. The conductive pattern 323c is connected through the conductive patterns of some of the through holes to the conductive pattern 323b which is connected to a ground terminal (not shown) provided on the lower surface of the circuit board 323. Also, the conductive pattern 323a is connected through the conductive patterns of the remaining through holes to the conductive pattern 323b which is connected to a signal output terminal (not shown) or a power input terminal (not shown) provided on the lower surface of the circuit board 323.

Also, on the circuit board 323, there are mounted electric and electronic parts such as a field effect transistor 326 and a capacitance 327 which cooperate together in constituting an impedance conversion circuit made within the box member 322. The field effect transistor 326 corresponds to an impedance conversion unit.

The box member base frame 324 includes openings respectively formed in the upper and lower end portions thereof and, on the upper and lower surfaces of the base frame 324 and on the outer surface thereof, there are respectively provided conductive patterns 324a, 324b and 324c which are formed as a continuous metal layer made of copper foil. To form the conductive pattern 324c provided on the outer surface of the box member base frame 324, a conductive paste may be applied to a recessed portion 324i which is formed in the present outer surface. The conductive pattern 324b provided on the lower surface of the base frame 324, as shown in FIG. 6, is connected through the conductive pattern 323c provided on the circuit board 323 to the conductive pattern 323b which is connected to a ground terminal (not shown) provided on the lower surface of the circuit board 323.

The peripheral edges of the lower opening of the box member base frame 324 are connected together into a unified body by the circuit board 323. And, the electric and electronic parts such as the field effect transistor 326 and capacitance 327 provided on the circuit board 323 are stored and arranged within the box member base frame 324.

As shown in FIG. 6, in the interior of the box member base frame 324, there is buried a metal layer 324d which is made of copper foil. That is, the box member base frame 324, according to the present embodiment, is made of a resin-made multi-layer substrate having three metal layers. In the wall of the box member base frame 324, there is formed more than one through hole 324e; and, on the respective inner peripheral surfaces of these through holes 324e, there are provided conductive patterns 324f which are continuous with the conductive patterns 324a and 324b respectively. Also, in the through holes 324e, there are filled conductive members 324g respectively; and, the conductive members 324g and the conductive patterns 324a and 324b cooperate together in constituting a conductive portion.

And, the metal layer 324d is electrically connected to the conductive pattern 323c provided on the circuit board 323 not only through the conductive portion 324h including the conductive patterns 324f and conductive members 324g of the through holes 324e but also through the conductive pattern 324b.

Also, in the wall of the box member base frame 324, separately from the through holes 324e, there are formed two or more through holes 340, while each of the through holes 340 has a circular-shaped section and an elliptic-shaped section and functions as a heat insulating cavity; and, the through holes 340, as shown in FIG. 7, are spaced at given intervals from each other and are formed so as to open through their associated conductive patterns 324a. On the respective inner peripheral surfaces of the through holes 340, there are provided conductive patterns 341 which are respectively continuous with the conductive patterns 324a, 324b and metal layer 324d. The interior portions of the through holes 340 are set in the vacuum and the lower opening end portions of the through holes 340 are glued to the conductive pattern 323c of the circuit board 323 with conductive adhesive and are thereby closed, so that the air-tight conditions thereof are kept. The degree of the vacuum thereof, preferably, may be higher than an intermediate degree of vacuum which is of the order of 100 Pa or lower. Such degree of vacuum can provide a desired heat insulation effect.

On the upper, lower and outer surfaces of the top substrate 325, there are provided conductive patterns 325a, 325b made of copper foil, respectively. In the top substrate 325, there is formed a sound hole 328 which is used to take in sounds from the outside.

As shown in FIGS. 6 and 7, between the box member base frame 324 and top substrate 325, there is held and fixed a ring-shaped spacer 329 which is made of an insulating film. The upper opening end portions of the through holes 340 of the box member base frame 324 are glued to the spacer 329 with conductive adhesive and are thus closed, whereby the air tight state of the through holes 340 is kept. In this manner, the peripheral edges of the upper openings of the box member base frame 324 are integrally connected to the top substrate 325 through the spacer 329 and vibration film 330.

On the upper surface of the spacer 329, there is stretched the vibration film 330 by adhesion, while the vibration film 330 is made of an insulating synthetic resin thin film such as a PPS (Polyphenylene Sulfide) film; and, on the lower surface of the vibration film 330, there is provided a conductive layer 330a formed by gold deposition. In the vibration film 330 and spacer 329, there are opened up through holes (not shown); and, the conductive layer 330a is allowed to conduct electricity to and from the conductive pattern 324a through conductive pastes filled into these through holes and through conductive adhesive interposed between the spacer 329 and box member base frame 324 (exactly, between the spacer 329 and conductive pattern 324a).

Within the box member base frame 324, on the lower surface of the vibration film 330, there is disposed a back plate 331 functioning as a pole plate with the spacer 329 interposed between them in such a manner that the back plate 331 is opposed to the vibration film 330. This back plate 331 is structured such that a film 331b made of PTFE (polytetrafluoroethylene) is glued to the upper surface of a back plate main body 331a made of a stainless steel plate. On the film 331b, there has been enforced a poling treatment by corona discharge or the like and, owing to the poling treatment, the film 331b constitutes an electret layer. In the present embodiment, the back plate 331 constitutes a back pole and thus the condenser microphone according to the present embodiment is structured as a condenser microphone of a back electret type.

Further, the back plate 331 is formed in a flat and substantially elliptic-shaped plate having a smaller outer peripheral shape than the inner peripheral shape of the box member base frame 324; and, between the inner and outer peripheral surfaces thereof, there is formed a clearance P. In the central portion of the back plate 331, there is opened up a penetration hole 332 which is used to allow the movement of the air caused by the vibration of the vibration film 330. The back plate 331 can be formed in such a manner that a stainless steel plate member with the film 331b glued thereto is blanked from the film 331b side, that is, from the upper side in FIG. 7 toward the lower side by a blanking blade (not shown).

As shown in FIGS. 6˜8, within the box member base frame 324, between the back plate 331 and circuit board 323, there is interposed a hold member 333 made of a spring member in a compressed state and, owing to the elastic force of the hold member 333, the back plate 331 is pressed from the opposite side of the vibration film 330 toward a direction where it is contacted with the lower surface of the spacer 329. This keeps a given clearance between the vibration film 330 and back plate 331 and, between them, there is formed a condenser portion which secures a given capacity.

The hold member 333 can be formed by blanking a plate member made of a stainless steel plate with the front and back surfaces gold plated; and, the hold member includes a substantially square-shaped frame portion 333a and four leg portions 333b respectively projecting obliquely toward the two sides of the lower portion of the hold member 333 from the four corners of the frame portion 333a. Therefore, between the leg portions 333b existing downwardly of the frame portion 333a, there is formed a space S. In the present embodiment, as shown in FIG. 6, the field effect transistor 326 on the circuit board 323 is disposed within the space S and the capacitance 327 is interposed between each pair of leg portions 333b. On the upper surface of the frame portion 333a of the hold member 333, there are provided four contact portions 334 formed as four spherical-shaped projecting portions which can be contacted with the lower surface of the back plate 331. And, on the leading end lower surfaces of the respective leg portions 333b, there are provided four contact portions 335 formed as four spherical-shaped projecting portions which can be contacted with part of the conductive pattern 323a on the circuit board 323. And, through this hold member 333, the back plate 331 is electrically connected to an impedance conversion circuit provided on the circuit board 323.

As shown in FIG. 6, in the top substrate 325, there is formed more than one through hole 336 and, on the inner peripheral surfaces of these through holes 336, there are provided conductive patterns 325c which are continuous with the conductive patterns 325a and 325b. Also, in each of the through holes 336, there is filled conductive adhesive 337a; and, the conductive adhesive 337a and conductive pattern 325c cooperate together in forming a conductive portion 337. The conductive layer 330a formed on the lower surface of the vibration film 330 is electrically connected to the conductive portion 337 by turning the conductive layer 330a toward the conductive portion 337. By the way, the conductive adhesive 337a may not be filled in the through hole 336 but only the conductive pattern 325c may be provided; and, when the conductive pattern 325c is not provided in the through hole 336, the conductive adhesive 337a may simply be filled into the through hole 336. However, the combined use of the conductive pattern 325c and conductive adhesive 337a can enhance the conductivity and shield property of the condenser microphone further.

And, the conductive patterns 325a and 325b of the top substrate 325 provides a conduction path which extends through the conductive portion 337, conductive layer 330a, conductive paste in a through hole (not shown) formed in the vibration film 330, conductive adhesive interposed between the spacer 329 and conductive pattern 324a, and conductive patterns 324a˜324c on the box member base frame 324, to the ground terminal on the circuit board 323.

In this condenser microphone 321, when sound waves from a sound source arrive through the sound hole 328 of the top substrate 325 at the vibration film 330, the vibration film 330 is vibrated according to the frequencies, amplitudes and waveforms of the sound waves. And, with the vibration of the vibration film 330, a clearance between the vibration film 330 and back plate 331 varies from its set value, thereby causing the impedance of the condenser to vary. The variation of the impedance is converted into a voltage signal by the impedance conversion circuit and the voltage signal is output.

Manufacturing Method

Next, description will be given below of a method for manufacturing the condenser microphone 321 having the structure.

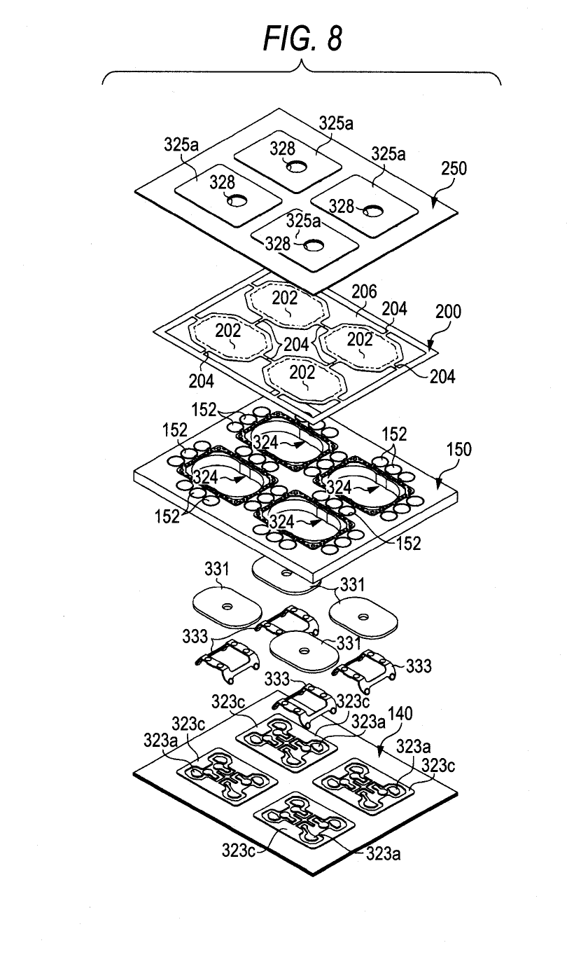

To manufacture the condenser microphone 321, after two or more aggregate parts are piled up and assembled together, they are divided. In this manufacturing method, as shown in FIG. 8, two or more condenser microphones 321 are manufactured using a circuit board member 140, a box body base frame forming member 150, a vibration film forming member 200, a top cover forming member 250, back plates 331, hold members 333 and the like.

The circuit board member 140 is an insulating substrate formed as an aggregate part which is used to form more than one circuit board 323. On the upper surface of the circuit board member 140, there are provided two or more conductive patterns 323a and 323c and, on the lower surface thereof, there are provided two or more conductive patterns 323b, while these patterns 323a, 323c and 323b are arranged at a given pitch in the longitudinal and transverse directions of the circuit board member 140. The circuit board member 140 corresponds to a mounting substrate aggregate sheet.

The box member base frame forming member 150 is a plate member formed as an aggregate member which is used to form two or more box member base frames 324. Between the portions of thereof that are used to provide the box member base frames 324, there are formed hole portions 152 at a given pitch in the longitudinal and transverse directions of the member 150 by hole machining such as by routing. Into each of the hole portions 152, there is filled a conductive paste, or the conductive paste is applied to the surface of the hole portion. The hole portion 152, after it is diced (which will be discussed later), provides the recessed portion 324i of the box member base frame 324; and, a conductive pattern 324c is formed by the conductive paste filled into or applied to the hole portion 152. The box member base frame forming member 150 corresponds to a frame member aggregate sheet.

The vibration film forming member 200 is a sheet member formed as an aggregate member in which two or more island members 202 used to form two or more vibration films 330 are arranged in the longitudinal and transverse directions of the member 200. Also, in the vibration film forming member 200, the island members 202, which are to provide the vibration films 330, are connected through connecting portions 204 to a frame member 206 and their adjoining island members 202. By the way, a spacer 329 is connected to the lower surfaces of the respective island members 202.

The top cover forming member 250 is a substrate formed as an aggregate member which is used to form two or more top substrates 325; and, in the top cover forming member 250, there are formed sound holes 328 and conductive patterns 325a and 325 at a given pitch in the longitudinal and transverse direction of the member 250. The top cover forming member 250 corresponds to a top cover substrate aggregate sheet.

To manufacture the condenser microphone 321, in a state where the field effect transistor 326, capacitance 327 and the like are previously mounted on the circuit board member 140, within a vacuum chamber (not shown), the circuit board member 140 is glued to the box member base frame forming member 150 with conductive adhesive to thereby unify them together. Next, the hold members 333 and back plates 331 are stored into such portions of the thus unified assembly that correspond to the box member base frame 324. After then, the vibration film forming member 200 is glued to the assembly with conductive adhesive. At the then time, owing to this conductive adhesive, the conductive pattern 324a corresponding to the box member base frame 324 is glued to the spacer 329 of the island member. Also, at the then time, the through hole 340 (cavity) is kept in a vacuum state. After then, using conductive adhesive, the top cover forming member 250 is glued to the assembly on which the vibration film forming member 200 is piled up. At the then time, the conductive patterns 325b of the top cover forming member 250 are glued to the vibration film 330 with the adhesive. After then, the assembly is discharged from the vacuum chamber (not shown) and is diced (cut off) using a diamond blade or the like, thereby providing two or more condenser microphones 321.

In FIG. 8, for convenience of explanation, there is shown a state where a total of four (2×2) condenser microphones 321 are produced; however, actually, hundreds of condenser microphones 321 are produced at the same time.

The condenser microphone 321 according to the present embodiment, which operates in the above-mentioned manner, can provide the following effects.

(1) According to the present embodiment, in the wall of the box member 322, that is, in the wall of the box member base frame 324, there is formed the through hole 340 which provides a cavity. Owing to this cavity, the heat insulating property of the box member 322 is enhanced, thereby being able to reduce thermal influences on parts provided within the box member 322 in a reflow treatment and the like. Therefore, for example, even when the condenser microphone 321 is mounted on the surface of an external substrate by a reflow treatment, loss or reduction of charges stored in the film 331b of the back plate 331 in the condenser portion, which is caused by heat applied in the reflow treatment, can be effectively prevented.

(2) According to the present embodiment, since the through hole 340 is evacuated and a vacuum layer is thereby formed in the cavity of the box member 322, the heat insulating property of the box member 322 can be enhanced further when compared with a structure in which an air layer is formed in the cavity. This can reduce the ill influences of the heat on parts provided within the box member 322 in the reflow treatment or the like.

(3) Also, according to the present embodiment, the opening end portions of the through hole 340 (cavity) are closed by the circuit board 323 (mounting substrate) and top substrate 325 (top cover substrate) respectively. As a result of this, the through hole 340 (cavity) is evacuated. Therefore, differently from a structure in which the air exists in the cavity, there is eliminated a possibility that gas existing within the through hole 340 can be thermally expanded by heat generated in the reflow treatment, which eliminates a fear that the box member base frame 324 and circuit board 323 can be separated from each other as well as the box member base frame 324 and top substrate 325 can be separated from each other. Also, owing to the vacuum state of the through hole 340, an attracting force can be applied to the circuit board 323 and top substrate 325 respectively connected to the box member base frame 324 according to a pressure difference between the vacuum and the air. This can prevent the separation of the circuit board 323 and top substrate 325 after assembled.

(4) Further, according to the present embodiment, the circuit board member 140 with the circuit boards 323 arranged in the longitudinal and transverse directions thereof and the top cover forming member 250 with the top covers arranged in the longitudinal and transverse directions thereof are piled up on the box member base frame forming member 150 with the box member base frames 324 each including the through hole 340 in the wall of the vacuum chamber, while the two members 140 and 250 close the member 150 in such a manner that the through hole can be held in a vacuum state. After then, by cutting the thus obtained assembly, the box members 322 are divided to individual ones. As a result of this, there can be easily obtained a condenser microphone which can provide the above-mentioned effect (3).

(5) In the box member base frame 324 according to the present embodiment, the through hole 340 (cavity) is formed by a multi-layer (three-layer) metal substrate including the conductive patterns 324a, 324b and metal layer 324d. As a result of this, the strength of the box member 322 can be increased.

(6) And, according to the present embodiment, the box member base frame 324 (frame member) is made of a resin-made multi-layer substrate including a metal layer 324a, 324b and 324d made of three layers of copper foil.

Therefore, after the respective composing members of the condenser microphone 321 are assembled, when the assembly is passed through a reflow furnace to mount the condenser microphone 321 onto an external substrate (not shown) by reflow soldering, the heat capacity of the box member base frame 324 (box member) has increased and become large. Owing to this, heat can be made difficult to be transmitted to the respective composing members within the box member 322; and, therefore, even when the heat in the reflow treatment is applied, the temperature within the box member base frame 324 can be prevented from rising. This can prevent the temperature of the condenser portion from rising. As a result of this, even when, as in the reflow treatment, high heat is applied into the box member 322, the possible thermal damage of the members stored within the box member 322 can be reduced.

Thus, for example, even when the condenser microphone is mounted onto the external substrate by a reflow treatment, it is possible to effectively prevent charges stored in the film 331b of the back plate 331 of the condenser portion from being lost or reduced by heat applied in the reflow treatment.

By the way, the heat capacity of an object is calorific value necessary to raise the temperature of the object by 1° C. and, specifically, it can be expressed by multiplying the mass of the object by the specific heat of the object.

According to the present embodiment, for example, the metal layer is made of copper foil, while the specific heat thereof is 0.092 cal/g/k and the density thereof is 8.96 grams/cm³.

On the other hand, in the case of ordinary glass cloth base epoxy resin, the specific heat thereof is 0.19 cal/g/k and the density thereof is 1.7˜2 grams/cm³.

Here, assuming that the density of the glass cloth base epoxy resin is 2 grams/cm³ and the volumes of this resin and cooper foil are the same, the glass cloth base epoxy resin and copper foil are compared with each other in the size of “density×specific heat”. The “density×specific heat” of the copper foil is 8.96×0.092=0.82432, whereas the “density×specific heat” of the glass cloth base epoxy resin is 2×0.19=0.38. Therefore, when the volumes of the glass cloth base epoxy resin and cooper foil are the same, the copper foil is double or larger than the glass cloth base epoxy resin in heat capacity.

(7) According to the present embodiment, the box member base frame 324 includes the conductive patterns 324a, 324b and metal layers 324d respectively provided in the two surfaces thereof and in the interior thereof, while the metal layers 324d provided in the interior of the box member base frame 324 are grounded. As a result of this, owing to the metal layers 324d provided in the interior of the box member base frame 324, the box member base frame 324 is shielded electromagnetically, thereby being able to reduce noises.

### Fourth Embodiment

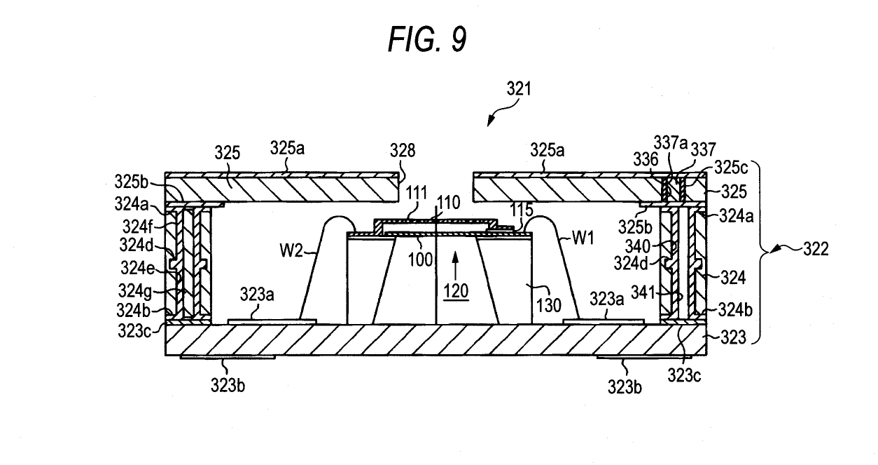

Next, description will be given below of a fourth embodiment of the invention with reference to FIG. 9. Parts, which are the same or correspond in structure to those used in the third embodiment, are given the same designations and thus the description thereof is omitted here. Thus, description will be given of parts which are different in structure from those in the third embodiment.

According to the condenser microphone 321 of the fourth embodiment, of the composing parts employed in the third embodiment, there are omitted the field effect transistor 326, capacitance 327, spacer 329, vibration film 330, back plate 331 and hold member 333.

And, instead of them, on the circuit board 323, there is disposed a silicone microphone element 120 which is made of a silicone substrate according to a semiconductor process technology.

The silicone microphone element 120 includes a vibration plate 100 functioning as a vibration film and a fixed plate 110 disposed opposed to the vibration plate 100 with a clearance between them, while both plates 100 and 110 are disposed on a die 130. Between the fixed plate 110 and vibration plate 100, there is interposed an insulation film 115 which is used to insulate them electrically. The vibration plate 100 is electrically connected to a connecting electrode (not shown) and is also connected through this connecting electrode and a wire W1 to a conductive pattern 323a provided on the circuit board 323. Also, the fixed plate 110 is electrically connected to a connecting electrode (not shown) and is also connected through this connecting electrode and a wire W2 to the conductive pattern 323a on the circuit board 323. In the fixed plate 110, there are formed two or more penetration holes 111. By the way, the detailed structures of the vibration plate 100 and fixed plate 110 are well known and thus the detailed description thereof is omitted here.

The vibration plate 100 and fixed plate 110 cooperate together in forming a microphone vibration portion. According to the thus structured silicone microphone element 120, as the vibration plate 100 is vibrated according to sound waves, the electrostatic capacity between the fixed plate 110 and vibration plate 100 is varied. Therefore, when the variations in the electrostatic capacity are measured by an impedance conversion unit (not shown) provided on the circuit board 323, the sound waves can be converted to electric signals.

Also, in the fourth embodiment, as described above, there is omitted the vibration film 330, and a conductive pattern 325b provided on the lower surface of the top substrate 325 is connected to the conductive pattern 324a of the box member base frame 324 with conductive adhesive. And, the upper opening end of the through hole 340 is closed by the conductive pattern 325b and the lower opening end thereof is closed by the conductive pattern 323c, whereby the through hole 340 is evacuated.

Thanks to the above structure, in the fourth embodiment as well, the formation of the evacuated through hole 340 in the wall of the box member base frame 324 enhances the heat insulating property of the box member base frame 324, thereby being able to reduce the ill influences of the heat on parts provided within the box member 322 in the reflow treatment.

By the way, this embodiment can also be changed and embodied in the follow manner.

In the above-mentioned respective embodiments, the through hole 340 is evacuated; however, the through hole 340 may also be filled with the air. In this case, the pressure of the air may be substantially equal to the atmospheric pressure, or it may also be slightly lower than the atmospheric pressure. In this case as well, since the heat insulating property of the box member 322 is enhanced, in the reflow treatment or the like, when heat is applied, the thermal influences of the heat on parts provided within the box member can be reduced.

In the above embodiments, the through hole 340 (cavity) is formed in the wall of the box member base frame 324. However, at the positions of the top substrate 325 and circuit board 323 that opposed to the through hole 340, there may be formed recessed portions to thereby increase the volume of the cavity. Also, at the position of the top substrate 325 or circuit board 323 that opposed to the through hole 340, there may be formed a recessed portion to thereby increase the volume of the cavity. In this case, when compared with the third embodiment, the volume of the cavity is increased, thereby being able to enhance the heat insulating effect further.

Also, as regards the cavity, the opening end side of the recessed portion may be closed with respect to the circuit board 323 to thereby form the cavity; or, there may be formed a through hole, and the two ends of this through hole may be closed to thereby form the cavity. The cavity may be formed only in the circuit board 323, or the cavity may be added to the structure of the third embodiment. Further, like an internal space 343 shown by a two-dot chained line in FIG. 6, there may be formed a space in the interior of the circuit board 323. Also, in the internal space 343, there may be formed an opening 344, which is an external opening, so as to be opposed to the box member base frame 324, and the opening 344 may be then evacuated similarly to the box member base frame 324 to thereby enhance its attracting force with respect to the box member base frame 324. Besides, the opening 344 may not be formed but, when forming the circuit board 323 which is a multi-layer substrate, the circuit board 323 may be evacuated similarly to the above-mentioned method to thereby evacuate the internal space 343. Also, the internal space 343 may be formed to have a honeycomb structure, thereby being able to increase the strength of the circuit board 323. Use of these structures can enhance further the heat insulating property in the reflow treatment. By the way, similarly to the circuit board 323, even when an internal space is formed in the top substrate 325, there can be obtained similar effects.

Also, to form the cavity, the opening end side of the recessed portion of the top substrate 325 may be closed, or a through hole may be formed in the top substrate 325 and the two ends of this through hole may be then closed. This cavity may be formed only in the top substrate 325, or, it may be added to the structure of the third embodiment. Also, the cavity may also be combined with the structure employed in the above-mentioned circuit board 323.

In the above embodiments, the through hole 340 functioning as the cavity is formed to have a circular section shape. However, the shape of the through hole is not limited to the circular section shape. For example, the through hole 340 may also have a regular hexagonal section shape or the like. Also, when there is arranged more than one through hole 340, they may have a regular hexagonal section shape and they are arranged adjacent to each other, thereby providing a honeycomb structure. Employment of the honeycomb structure can enhance the strength of the structure of the portion where the through holes 340 are formed.

In the above embodiments, the box member base frame 324 is made of a resin-made multi-layer substrate having three layers. However, the box member base frame 324 may also have four layers or five or more layers. In this case as well, the heat capacity of the box member base frame 324 can be increased.

In the above embodiment, the metal layer is made of copper foil. However, of course, the metal layer may also be made of another metal.

In the above embodiments, the back plate main body 331a is made of a stainless steel plate. However, it may also be made of a brass plate, a titanium plate or other similar metal plate.

In the above embodiments, the invention is embodied in a condenser microphone of a back electret type. However, the invention may also be embodied in a condenser microphone of a front electret type in which an electret layer is formed on the inner surface of the box member 322 (for example, in FIG. 6, on the side surface that is situated upwardly of the vibration film 330).

And, the invention may also be embodied in a condenser microphone of a foil electret type in which the vibration film 330 is made of a high polymer film for an electret.

Also, the invention may also be embodied in a condenser microphone of a charge pump type which includes a booster circuit.

When this structure is employed, instead of the electret layer, there are provided electrodes in the vibration film 330 and back plate 331 in such a manner that the electrodes are disposed opposed to each other.

In the above embodiments, the metal layer may be made of, besides copper, metal such as aluminum or silver that has conductivity.

What is claimed is:

1. A condenser microphone comprising:
a condenser portion including a vibration film and a plate disposed opposed to each other;
an impedance conversion unit that converts the variations of the electrostatic capacity of the condenser portion to electric impedances; and
a box member that stores the condenser portion and the impedance conversion unit therein, and includes a heat insulating portion.

2. The condenser microphone according to claim 1, wherein:
the box member is made of an insulating member;
the box member includes: a base frame including a storage space formed to extend therethrough; and a substrate for closing the opening ends of the storage space;
the box member stores an electro-acoustic conversion unit in the storage space;
the substrate is formed in multiple layers including an insulating layer and a conductive layer in such a manner that the conductive layer is buried in the insulating layer; and
the conductive layer is formed in a mesh-like shape to thereby form the heat insulating portion.

3. The condenser microphone according to claim 2, wherein
the conductive layer is electrically connected to a through hole formed in the substrate.

4. The condenser microphone according to claim 3, wherein:
the substrate includes: a first substrate including a circuit pattern for the impedance conversion unit, the first substrate closing one opening end of the storage space; and a second substrate including a sound hole, the second substrate closing the other opening end of the storage space; and
the conductive layer is provided on at least one of the first and second substrates.

5. The condenser microphone according to claim 4, wherein:
the substrate includes a sound hole; and
the conductive layer is formed so as to cross the sound hole.

6. The condenser microphone according to claim 4, wherein
a hole formed in the conductive layer is filled with resin constituting the insulating layer.

7. The condenser microphone as set forth in claim 4, wherein
the hole of the conductive layer configures a space.

8. The condenser microphone according to claim 1, wherein
the heat insulating portion is made by a cavity formed in the wall of the box member.

9. The condenser microphone according to claim 8, wherein:
the box member includes: a mounting substrate with the impedance conversion unit mounted thereon; a frame member having a pair of openings, with the peripheral edge of one opening being integrally connected to the mounting substrate and surrounding the impedance conversion unit; and a top cover substrate integrally connected to the peripheral edge of the other opening of the frame member; and
the cavity is formed in at least one of the mounting substrate, frame member and top cover substrate.

10. The condenser microphone according to claim 9, wherein:
the cavity includes a through hole formed in the frame member; and
both of the opening ends of the through hole are closed by the mounting substrate and the top cover substrate respectively.

11. The condenser microphone according to claim 8, wherein:
the box member includes a cavity functioning as the heat insulating portion; and
the box member is made of a substrate including two or more metal layers.

12. The condenser microphone according to claim 9, wherein
the cavity of the frame member has a honeycomb structure.

13. The condenser microphone according to claim 8, wherein:
the box member includes: a circuit board with a die mounted thereon; a frame member connected to the circuit board and surrounding the die; and a top cover substrate integrally connected to the frame member; and
the die includes a microphone vibration portion made by a semiconductor process technology.

14. The condenser microphone according to claim 10, wherein
the cavity is filled with the air.

15. The condenser microphone according to claim 10, wherein
the cavity is evacuated.
